(19) United States
(12) Patent Application Publication
(10) Pub. No.: US 2019/0138938 A1
(43) Pub. Date: May 9, 2019

(54) TRAINING A CLASSIFIER USED TO DETECT NETWORK ANOMALIES WITH SUPERVISED LEARNING

(71) Applicant: Cisco Technology, Inc., San Jose, CA (US)

(72) Inventors: Jean-Philippe Vasseur, Saint Martin D'uriage (FR); Grégory Mermoud, Veyras (CH); Vinay Kumar Kolar, San Jose, CA (US)

(21) Appl. No.: 15/803,968

(22) Filed: Nov. 6, 2017

(51) Int. Cl. G06N 99/00; H04L 12/26

(52) U.S. Cl. CPC G06N 99/005; H04L 41/16; H04L 43/08

(57) ABSTRACT

In one embodiment, a service receives relevancy feedback regarding anomalies detected in a network by one or more unsupervised learning-based anomaly detectors. The service generates a set of rules based on those of the anomalies deemed relevant by the relevancy feedback. The service uses the set of rules to trigger collection of data features from the network. The service trains a supervised learning-based classifier using the data features collected from the network.

### TECHNICAL FIELD

The present disclosure relates generally to computer networks, and, more particularly, to training a classifier used to detect anomalies with supervised learning.

### BACKGROUND

Networks are large-scale distributed systems governed by complex dynamics and very large number of parameters. In general, network assurance involves applying analytics to captured network information, to assess the health of the network. For example, a network assurance system may track and assess metrics such as available bandwidth, packet loss, jitter, and the like, to ensure that the experiences of users of the network are not impinged. However, as networks continue to evolve, so too will the number of applications present in a given network, as well as the number of metrics available from the network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIG. 4 illustrates an example architecture for training a classifier to detect network anomalies;

FIG. 5 illustrates an example of using feedback regarding detected anomalies in a network;

FIG. 6 illustrates an example display of anomalies detected in a network;

FIG. 7 illustrates an example graph of network features that may contribute to an anomaly;

FIG. 8 illustrates an example set of patterns associated with low throughput anomalies;

FIGS. 9A-9B illustrate examples of wireless features that affect throughput; and

FIG. 10 illustrates an example simplified procedure for training a network classifier.

### DESCRIPTION OF EXAMPLE EMBODIMENTS

### Overview

According to one or more embodiments of the disclosure, a service receives relevancy feedback regarding anomalies detected in a network by one or more unsupervised learning-based anomaly detectors. The service generates a set of rules based on those of the anomalies deemed relevant by the relevancy feedback. The service uses the set of rules to trigger collection of data features from the network. The service trains a supervised learning-based classifier using the data features collected from the network.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

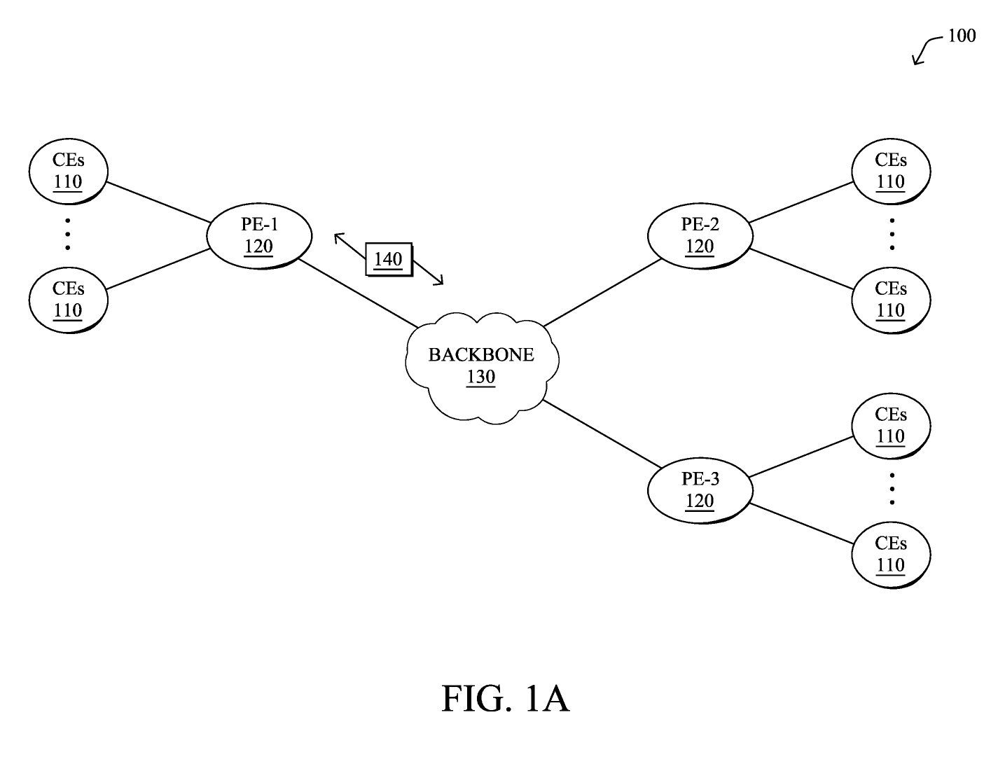

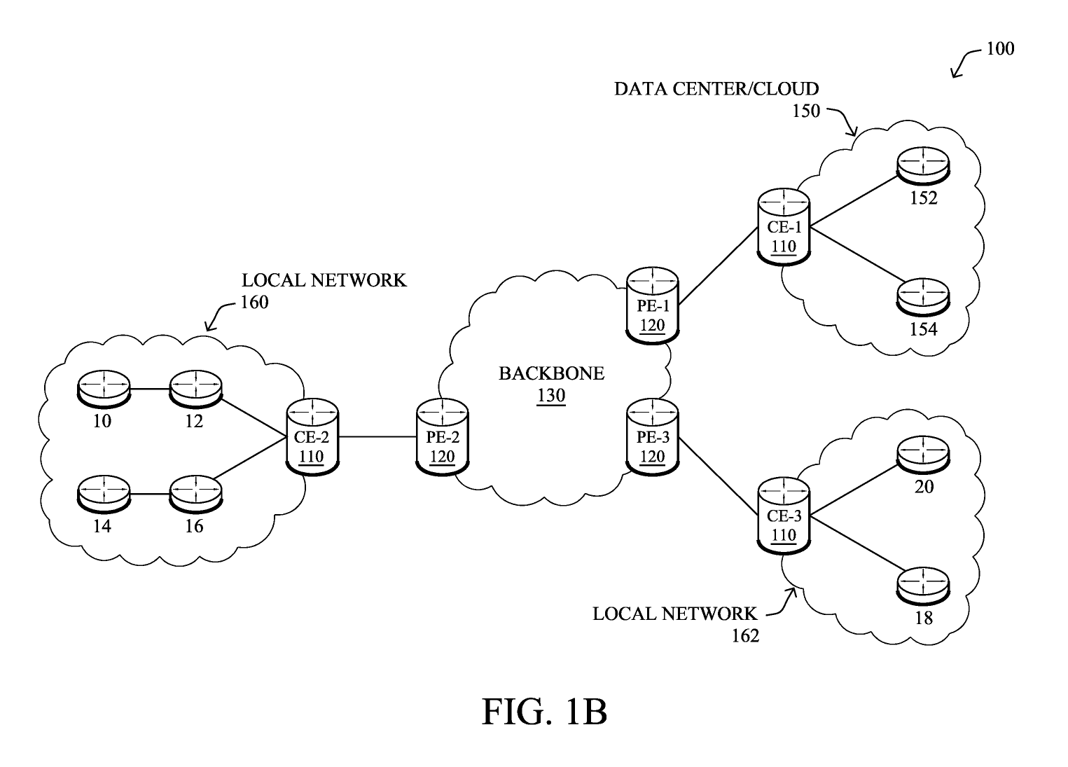

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement (SLA) characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed SLA, whereas Internet links may either have no SLA at all or a loose SLA (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

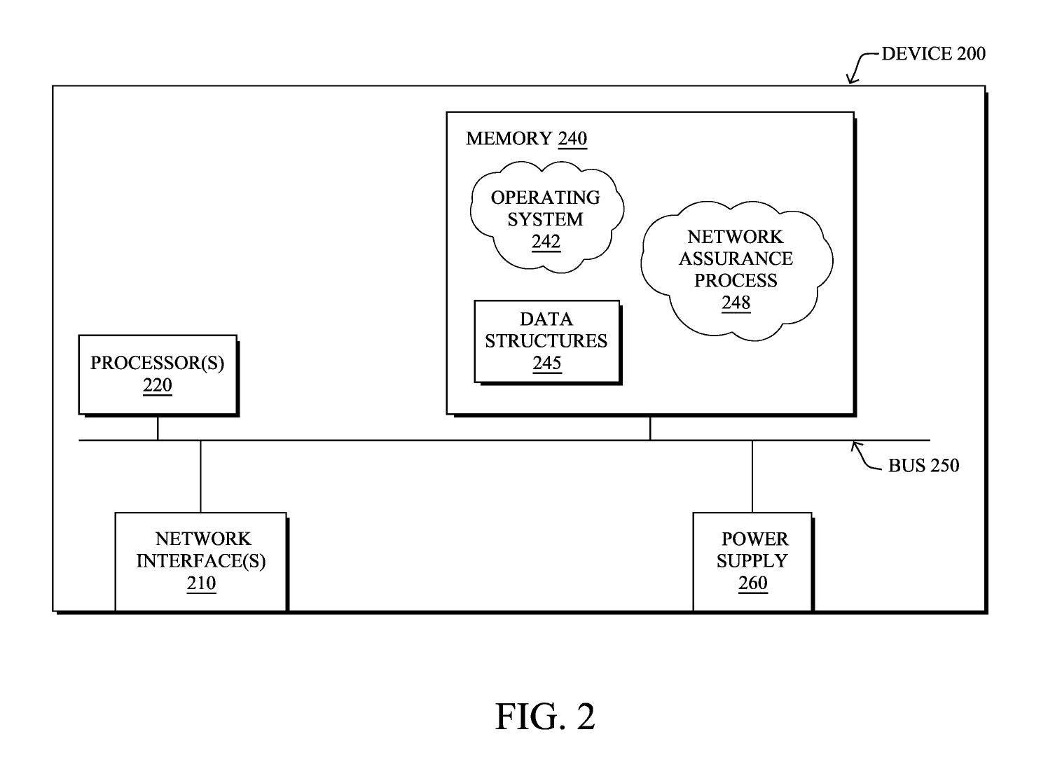

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason_code to the assurance system. To evaluate a rule regarding these conditions, the network assurance system may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

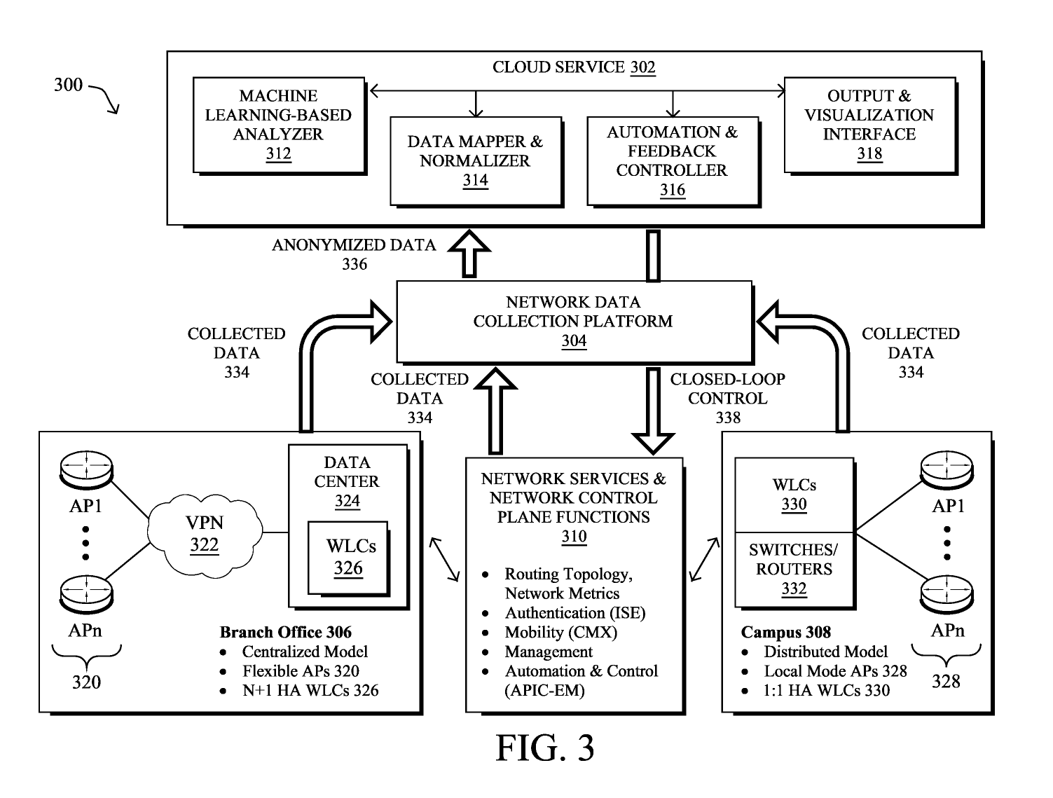

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an organization (e.g., a company, school, etc.) that includes any number of local networks. For example, cloud service 302 may oversee the operations of the local networks of any number of branch offices (e.g., branch office 306) and/or campuses (e.g., campus 308) that may be associated with the organization. Data collection from the various local networks/locations may be performed by a network data collection platform 304 that communicates with both cloud service 302 and the monitored network of the organization.

The network of branch office 306 may include any number of wireless access points 320 (e.g., a first access point API through nth access point, APn) through which endpoint nodes may connect. Access points 320 may, in turn, be in communication with any number of wireless LAN controllers (WLCs) 326 located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point API through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint device, networking device in branch office 306 or campus 308, or a network service or control plane function 310, to adjust its operations (e.g., by signaling an endpoint to use a particular AP 320 or 328, etc.).

As noted above, networks are large-scale distributed systems governed by complex dynamics and very large number of parameters. When a problem arises, the network operators must first make sense of the millions of data points generated every minute by every network element, infrastructure servers and connected clients. The prime objective of a network assurance system, such as network assurance system 300, is to aid in this task. Notably, system 300 may gather millions of data points from various sources (e.g., SNMP, JSON files, system logs, etc.) in the network in support of its functions, including cognitive analytics and predictive analytics.

In many circumstances, network assurance systems, such as system 300, may use unsupervised machine learning for purposes of anomaly detection. Such an approach can be quite powerful to model the normal behaviors of the network and flag outliers/anomalies as they arise. This contrasts with supervised-based approaches, such as ANNs, random decision forests, and the like, that are trained to specifically predict a known outcome (e.g., a label). Supervised learning is by far the most mature and well-understood area of machine learning, but it requires a large number of labeled data for training. However, in the case of networking anomalies, such labels are not always available, making unsupervised approaches more suitable for certain situations.

While unsupervised approaches are effects at detecting network anomalies without labeled training data, they are not without their own challenges. Notably, the efficacy of an unsupervised-based model is usually assessed by observing the receiver operating characteristics (ROC) and the elated area under the curve (AUC), which highlight the tension between recall and precision in unsupervised approaches. In other words, the higher the recall exhibited by an unsupervised anomaly detector, the lower its precision, and vice versa.

Training a Classifier Used to Detect Network Anomalies with Supervised Learning

The techniques herein introduce a closed loop control mechanism for a network assurance system that leverages both unsupervised and unsupervised learning, to assess the network. Initially, the system may detect network anomalies using one or more unsupervised learning-based anomaly detectors. Then, the system may automatically generate a set of rules to capture features and labels, based on the relevancy of the detected anomalies to the user. In further aspects, the system may use the captured features and labels to train a supervised learning-based classifier. Such a classifier may be configured to detect anomalies and provide interpretable patterns to the user. In further aspects, the classifier may be retrained by incrementally adjusting the scope of rules, and thus captured information, according to the relevancies indicated by the user.

Specifically, according to one or more embodiments of the disclosure as described in detail below, a service receives relevancy feedback regarding anomalies detected in a network by one or more unsupervised learning-based anomaly detectors. The service generates a set of rules based on those of the anomalies deemed relevant by the relevancy feedback. The service uses the set of rules to trigger collection of data features from the network. The service trains a supervised learning-based classifier using the data features collected from the network.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

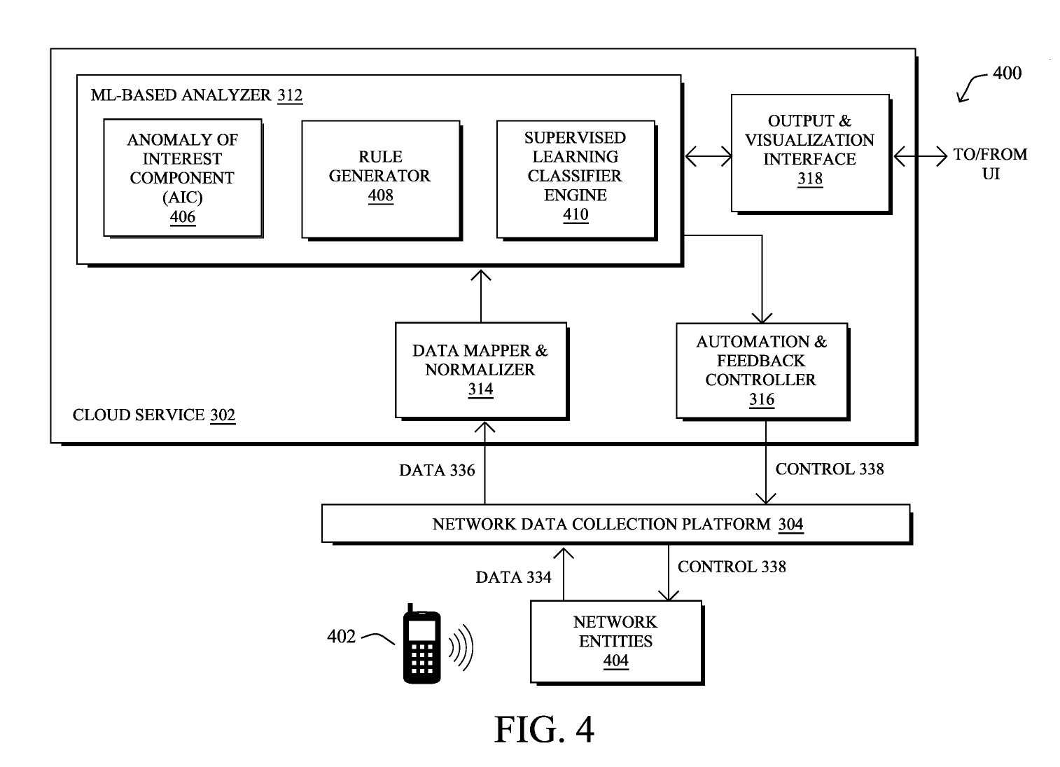

Operationally, FIG. 4 illustrates an example architecture 500 for performing mobility path analysis in a network assurance system, according to various embodiments. In general, architecture 400 may include any or all of the following components: an anomaly of interest component (AIC) 406, a rule generator 408, and/or a supervised learning classifier engine 410. In various embodiments, the components of architecture 400 may be implemented within a network assurance system, such as system 300 shown in FIG. 3. Accordingly, the components 406-408 of architecture 400 shown may be implemented as part of cloud service 302, as part of network data collection platform 304, and/or on one or more network elements/entities 404 within the monitored network itself. Further, these components may be implemented in a distributed manner or implemented as its own stand-alone service, either as part of the local network under observation or as a remote service. In addition, the functionalities of the components of architecture 400 may be combined, omitted, or implemented as part of other processes, as desired.

During operation, a client device 402 may leverage one or more of network entities 404, to communicate wirelessly with the local network. For example, network entities 404 may include wireless APs, WLC, switches, routers, or the like, that provide network connectivity to client device 402. In turn, network entities 404 may report information regarding the roaming and other wireless conditions associated with client device 404 to network data collection platform 304 as part of data 334. Network data collection platform 304 may then pass this data on to cloud service 302 for analysis by machine learning (ML)-based analyzer 312.

Anomaly of interest component (AIC) 406 may be an unsupervised machine learning-based process configured to detect network anomalies and explore the space of anomalies of interest. As noted, AIC 406 may either reside on premise (e.g., hosted on one or more network entities 404) or in the cloud, as part of cloud service 302. AIC 406 can use a variety of unsupervised learning approaches such as those using statistical moments (e.g., AIC 406 may maintains some moments of the data distribution, such as the median, and detect anomalies based on the distance of the point to these moments), auto-encoder approaches (e.g., AIC 406 may learn to reconstruct multi-dimensional samples and detect anomalies based on the reconstruction error), or any other suitable form of unsupervised learning anomaly detector.

Once AIC 406 detects a network anomaly, AIC 406 may send a custom message to a user interface (UI) via output and visualization interface 318 for review by a user. The message may include information regarding the detected anomaly, such as the network metrics/features that triggered the anomaly detector, the anomaly score of the anomaly, and potentially a flag indicating that the anomaly is exploratory. Indeed, the main functionality of AIC 406 is to detect network anomalies and assess their relevancy by obtaining relevancy feedback from the user.

AIC 406 may also keep track of the distribution of anomalies reported to the user interface via output and visualization interface 318 and try to maximize the variety of the reported anomalies. By doing so, the relevancy learning by AIC 406 can be accelerated, since the user is able to provide relevancy feedback regarding a variety of anomalies.

In some embodiments, the information regarding detected anomalies sent by AIC 406 to the UI may also be augmented with additional “context features” that can be used by the user to evaluate his or her level of interest. AIC 406 may retrieve such context features by constructing additional features from the data/features associated with the anomaly or by calling application programming interfaces (APIs) used with other systems such as a Remote Authentication Dial-In User Service (RADIUS) server, wireless AP, or network access control server, such as an Identity Server Engine (ISE).

By way of example, if AIC 406 is predicting low throughput anomalies for a given period of time, then AIC 406 may also collect and report the context features to the UI that may explain the probable root-causes of the anomalies, such as the amounts of traffic, packet errors, and clients that exhibited low received signal strength indicators (RSSIs) during this period. In another example, upon detecting an anomaly involving client device 402 with IP address IP1, AIC 406 may request from a network access control server, such as an ISE, additional information about the user ID and device type associated with client device 402. Such information may be available through the use of static or dynamic device profiling, from the AP in network entities 404 that client device 402 joined, or the like.

According to various embodiments, another component of architecture 400 may be rule generator 408, which is in charge of measuring the interest of a particular regarding the reported anomaly information (e.g., how relevant the user considers the conditions). For example, the user may specify an interest in anomalous conditions such as “percentage of roaming failure rate is higher than 90%,” or “roaming failure rate has increased by 50% on an AP where the number of clients was greater than 100,” which rule generator 408 can then translate into formal rules for capturing training feature data from the network. In some cases, common traits/patterns across different anomalies can also be identified by rule generator 408 for the possible generation of a feature capture rule, depending on the relevancy feedback from the user interface.

In some cases, rule generator 408 may start with a set of pre-defined set of conditions or rules, which it can then rank over time based on the relevancy feedback from the user. In turn, various strategies may be used to “broaden” the scope of anomaly detection by generating more general rules. For example, if the common traits between N-number of anomalies of interest (which received high relevancy feedback from the user) is that the number of impacted clients was greater than 50 (the common traits), this can lead to a single rule for all anomalies with more than 50 clients. If the system receives negative feedback for this condition from the UI (e.g., the user did not believe anomalies involving more than 50 clients to be of relevance), this means that the common traits-based rule generation by rule generator 408 was too broad. In turn, rule generator 408 may refine its rule generation strategy, accordingly.

Once rule generator 408 has generated a rule, cloud service 302 may deploy this rule to capture those data features associated with anomalies that match that rule. In some cases, rule generator 408 may first employ a validation period before deploying a rule whereby at least X % of all anomalies matching the rule receive positive relevancy feedback from the UI. Said differently, a rule generated by rule generator 408 may be used to capture all relevant data features (e.g., network metrics), which can then be used to train a supervised learning-based classifier. To that end, a set of automatically generated rules from rule generator 408 can be used within cloud service 302, as part of network data collection platform 304, or even uploaded to network entities 404. Note that the collected features from a generated rule can also be gathered from a variety of sources. For example, rule generator 408 can send the rules to network entities 404 (e.g., a router that performs packet capture for all traffic matching the rules), an ISE to gather information for a given MAC or IP address, or the like.

In various embodiments, architecture 400 may also include supervised learning classifier engine 410 that is configured to recast the unsupervised learning strategy into a supervised learning issue. In particular, supervised learning classifier engine 410 may be configured to train a supervised learning-based classifier using the data features captured from the rules. In one embodiment, the trained classifier can then replace the rules and/or anomaly detection functions (e.g., by deploying the classifier to the network, as part of cloud service 302, etc.).

Even after deployment of the trained classifier, the system may still continue to receive relevancy feedback from the UI regarding the anomalies and patterns generated using the new classifier. In some embodiments, this relevancy feedback can also be used to trigger further retraining of the classifier and possibly using additional data features. Conversely, if the relevancy feedback indicates that the relevancy is below a defined threshold (e.g., the user flags a threshold percentage of anomalies of a certain type detected by the classifier as irrelevant), supervised learning classifier engine 410 can even retrain the classifier to stop detecting this type of anomaly.

In yet another embodiment, supervised learning classifier engine 410 may use the percentage of relevant user feedback to broaden or narrow down the scope of a rule used to gather labels and subsequently train the classifier. For example, once the classifier is used to detect a given type of anomaly (e.g. all anomalies with more than 50 clients, when the type of device is Apple and Release is OS 11.3.2), if the success rate in terms of user relevancy exceeds some threshold (e.g. >95%), the system may automatically regenerate a new rule with a broader scope (e.g. all anomalies with more than 50 clients, when the type of device is Apple). Doing so allows the system to gather new labels so as to retrain a classifier with a broader scope. Such an incremental approach may be used to broaden the scope of the classifier until a point where the level of relevancy starts decreasing.

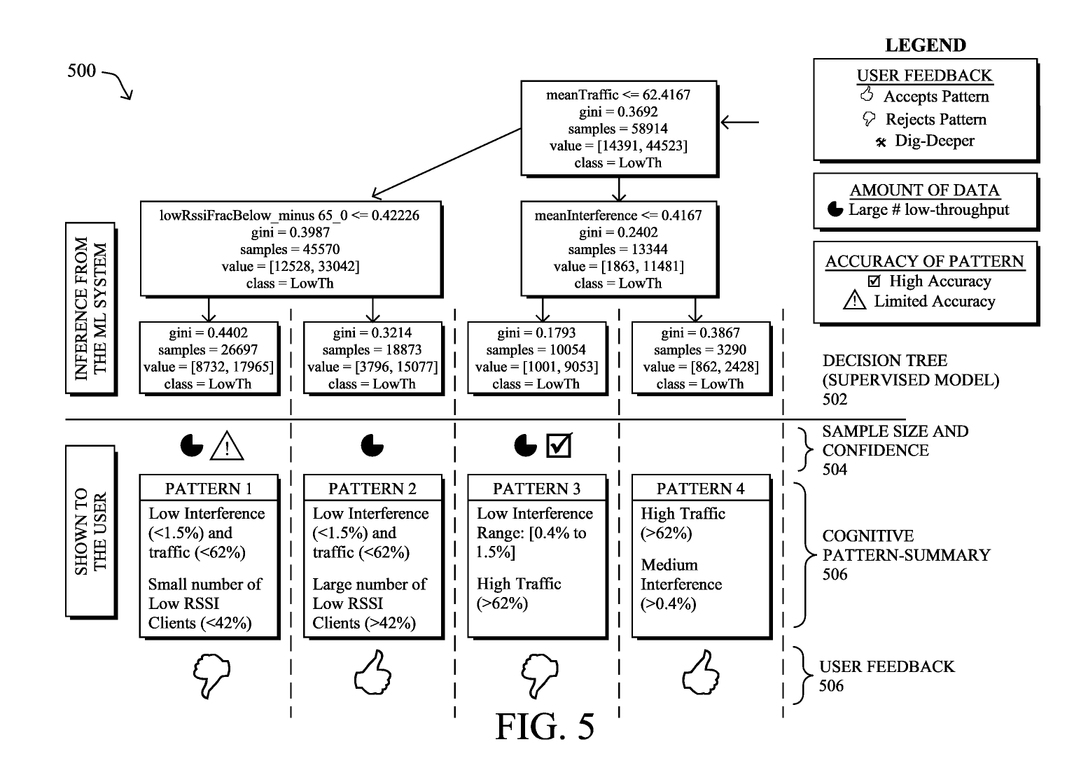

FIG. 5 illustrates an example 500 of using feedback regarding detected anomalies in a network, according to various embodiments. As shown, the system first uses unsupervised anomaly detection to detect all possible low-throughput scenarios/anomalies in the network. Then, the system generates rules based on these anomalies, while also filtering out those of anomalies that were not deemed relevant by the user (e.g., the cases where less than two clients were associated to an AP). In turn, the system then uses the collected data from the rules to train a supervised learning-based classifier, such as the decision tree 514 shown. Generally, decision tree 514 includes all of the possible and/or relevant features that can affect throughput (e.g., RSSI of clients, interference, packet errors, etc.). The patterns are then inferred by automatically analyzing tree 514, and the patterns are then presented to the user in a language that is easily understandable.

Based on the decision tree 514, various patterns can be extracted from the detected anomalies and presented to the user, to obtain relevancy feedback. As shown, each pattern presented to the user may indicate the sample size and confidence 516. For example, various indicia may be displayed to indicate the amount of data associated with a given pattern, as well as whether the accuracy of the pattern is deemed high accuracy or of limited accuracy. The data presented to the user can also include a cognitive pattern summary 506 that explains the rule components to the user that are associated with the pattern. For example, pattern 1 may indicate that the corresponding anomalies all involve low interference (<1.5%) and traffic (<62%), as well as a small number of low RSSI clients (<42%). In turn, the user may provide relevancy feedback 506 regarding the presented patterns. Such feedback 506 may be on a binary scale (e.g., thumbs up or down), on a larger rating scale (e.g., 1-5, 1-10, A-F, etc.). In some cases, feedback 506 may also include the option to “dig deeper,” thereby signifying that the system should explore these conditions through an expanded rule.

The network admin can again indicate a thumbs up/down based on what the pattern interpreted and their expertise. This feedback is taken back to re-label the anomalies. For example, when the network admin chooses Pattern 1 shown (e.g., low throughput anomalies due to only two main factors: low traffic and low interference), the admin may decide that this is, in fact, not a low-throughput anomaly-of-interest since there might be inactive users. This feedback can be used to re-label all low-throughput anomalies with the above condition as not-anomalous. Thus, the system iteratively detects strong anomalies and the anomaly patterns using a mix of supervised and unsupervised approaches.

Using the above techniques, a prototype was constructed to assess a network deployment with more than 3,300 radios and 20,000 users. First, a variety of unsupervised, time-series and distribution comparison-based anomaly detectors were deployed, to detect anomalies in the network. In turn, the most prominent anomalies were then displayed to the user, along with other information, such as the anomaly scores from the detectors, to convey information about the anomalies to the user and obtain relevancy feedback from the user.

Based on the displayed anomaly information, the user of the prototype provided relevancy feedback (e.g., thumbs up or down) regarding the displayed anomaly information. Using this feedback, the system learned some of the characteristics of the anomalies, such as by assessing the conditions/features associated with the anomalies.

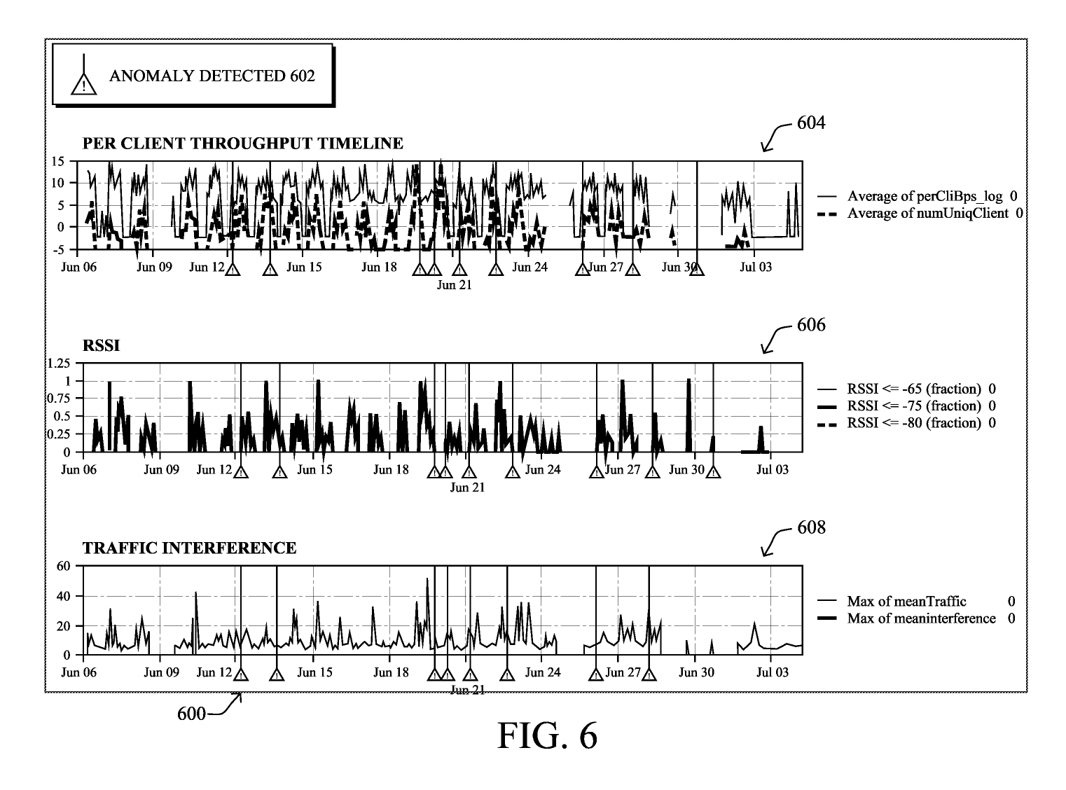

FIG. 6 illustrates an example display 600 of some of the anomalies detected in the network by the prototype system. As shown, the user was presented with charts 604-606 regarding various network measurements. Anomalies 602 for these measurements over time were also indicated, allowing the user to quickly visualize the frequency of such anomalies, as well as the extent of the anomalies. In addition to the throughput metrics in chart 604, the prototype system was also configured to display other metrics that can also affect throughput, such as the client RSSI values in chart 606 and traffic interference measurements in chart 606.

From the relevancy feedback, the prototype system then constructed a set of features. For example, in the case of low throughput anomalies, the system constructed features based on traffic, interference, operating channel (e.g., channel band, channel numbers, etc.), client signal strengths (e.g., RSSI, SNR), and other RF metrics that are observed at the normal and anomalous points in time. Several supervised models were then run to detect anomalous vs. non-anomalous patterns.

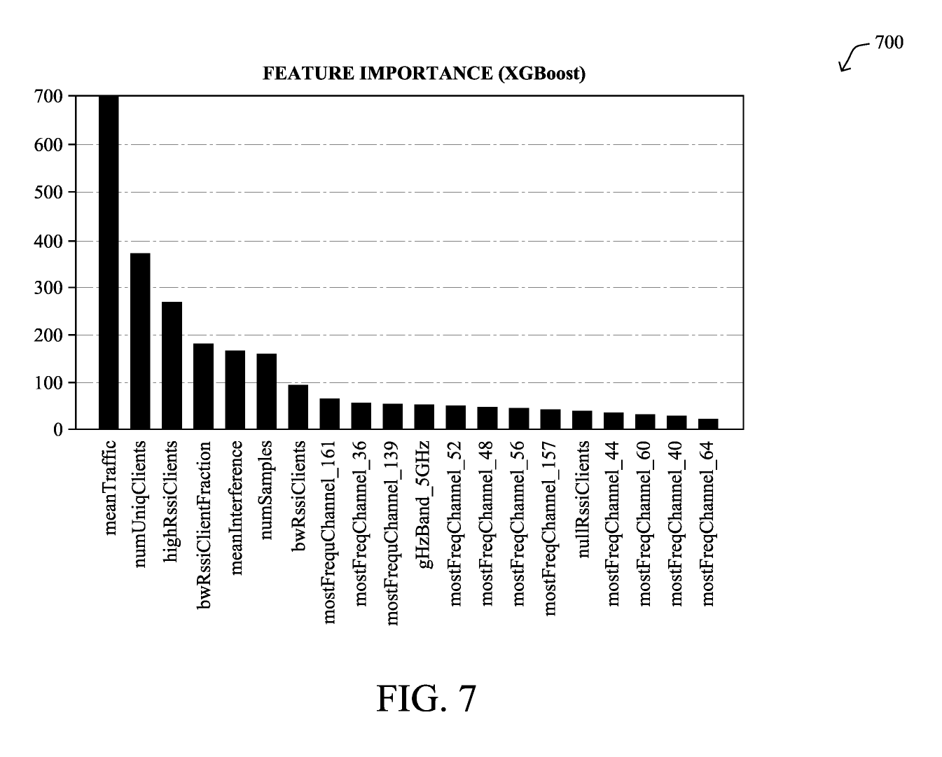

FIG. 7 illustrates an example graph 700 of network features that may contribute to a low throughput anomaly, according to various embodiments. As shown, the features (x-axis) with the highest importance scores (y-axis) are the most important to distinguish between low and normal throughput in the network. The importance of these features was identified using XGBoost, which is a gradient boosting application.

In another approach to determining the importance of the features, deeper patterns were detected by using decision trees and deriving the patterns from the decision trees. These decision trees can be used to determine the most prominent, but succinct, rules, such as decision tree 502 illustrated in FIG. 5. This approach entails inputting the set of features and the anomaly label, and outputs the set of rules that are inferred by the decision tree. An example output of such rules is shown in Table 1 below:

TABLE 1

| | | Sample Split | Total |
|---|---|---|---|
| Gini index | Identified Rules | [Normal.LowThroughput] | Samples |
| 0.195845568 | (numUniqClients > 4.5) & | [113.914] | 1027 |
| | (mostFreqChannel_36 > 0.5) & | | |
| | (meanTraffic ≤ 27.5833320618) & | | |
| | (lowRssiFracBelow_minus_80_0 > 0.163333326578) & | | |
| | (numUniqClients ≤ 6.5) | | |
| 0.208073636 | (numUniqClients > 4.5) & | [322.2408] | 2730 |
| | (mostFreqChannel_36 > 0.5) & | | |
| | (meanTraffic > 27.5833320618) & | | |
| | (lowRssiFracBelow_minus_65_0 > 0.39565217495) & | | |
| | (lowRssiFracBelow_minus_80_0 ≤ 0.207142859697) & | | |
| | (meanTraffic ≤ 75.5) | | |
| 0.212930417 | (numUniqClients ≤ 4.5) & | [255.1850] | 2105 |
| | (meanTraffic > 11.4166660309) & | | |
| | (lowRssiFracBelow_minus_65_0 ≤ 0.651515126228) & | | |
| | (lowRssiFracBelow_minus_75_0 > 0.316666662693) & | | |
| | (lowRssiFracBelow_minus_65_0 ≤ 0.563492059708) & | | |
| | (meanTraffic > 12.5833339691) | | |
| 0.216355957 | (numUniqClients > 4.5) & | [339.2408] | 2747 |
| | (mostFreqChannel_36 > 0.5) & | | |
| | (meanTraffic > 27.5833320618) & | | |
| | (lowRssiFracBelow_minus_65_0 > 0.39565217495) & | | |
| | (lowRssiFracBelow_minus_80_0 ≤ 0.207142859697) | | |

The output above consists of four fields that can be automatically analyzed for discovering patterns for anomaly of low throughput (in this example):
Gini Index: This metric describes the “confidence.” A value of “0” indicates highest confidence and a value of “0.5” indicates low confidence. Other similar measures which quantify the “goodness” of split in the decision tree (e.g., entropy or metrics from chi-squared tests) can also be used.
Identified Rules: These are the patterns of interest that will assist the network admin to determine the root cause of an anomaly. It lists the conditions on features that were prominently observed.
Sample Split: This describes two elements: the number of samples that are normal and number of samples that have the anomaly.
Total Number of Samples: This indicates the total number of samples associated with the corresponding rules.

From the above output, the most prominent patterns were extracted by selecting patterns that have: 1.) high confidence (e.g., a Gini score of <0.4), and 2.) a high number of samples (e.g., rules that have a total sample of x % of the input samples). The selected rules were then codified such that the administrator can understand the pattern. In addition, the confidence of the tree was also predicted using metrics such as entropy or Gini index. This information allows the administrator to determine whether a given pattern is a strong pattern or weak pattern. Note that in another embodiment, the rules can be codified further and displayed as a sequence of drill downs.

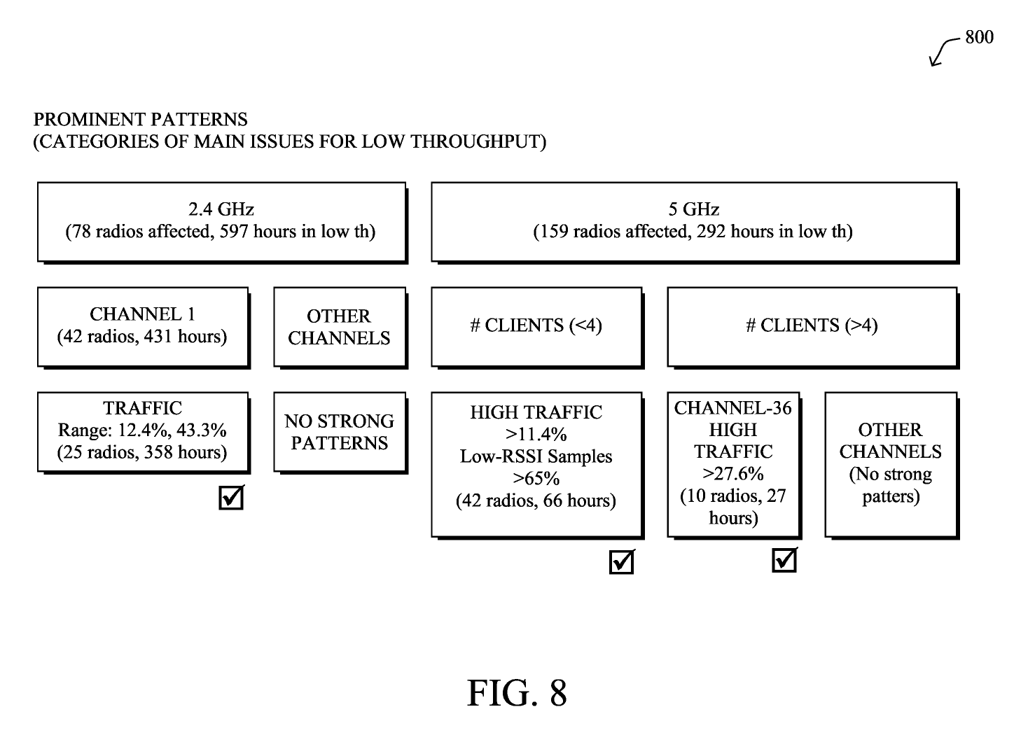

FIG. 8 illustrates an example set of patterns 800 associated with low throughput anomalies, according to various embodiments. From the analysis of the decision tree, the patterns 800 shown were identified as the most prominent across the low throughput anomalies in the network. As shown, each pattern may be broken down into sub-categories, allowing the user to quickly identify the patterns most common to these types of anomalies. For example, one pattern associated with the low throughput anomalies is an AP using 5 GHz, with more than four attached clients, on channel 36, and under high traffic conditions (e.g., >27.6%). Such information provides insight to the user regarding the potential underlying causes of the throughput anomalies.

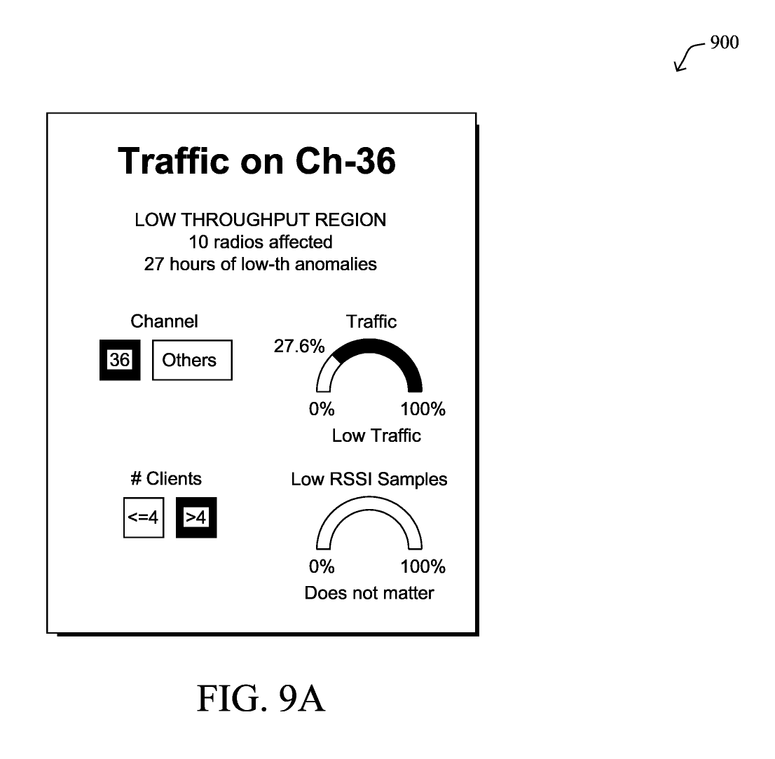

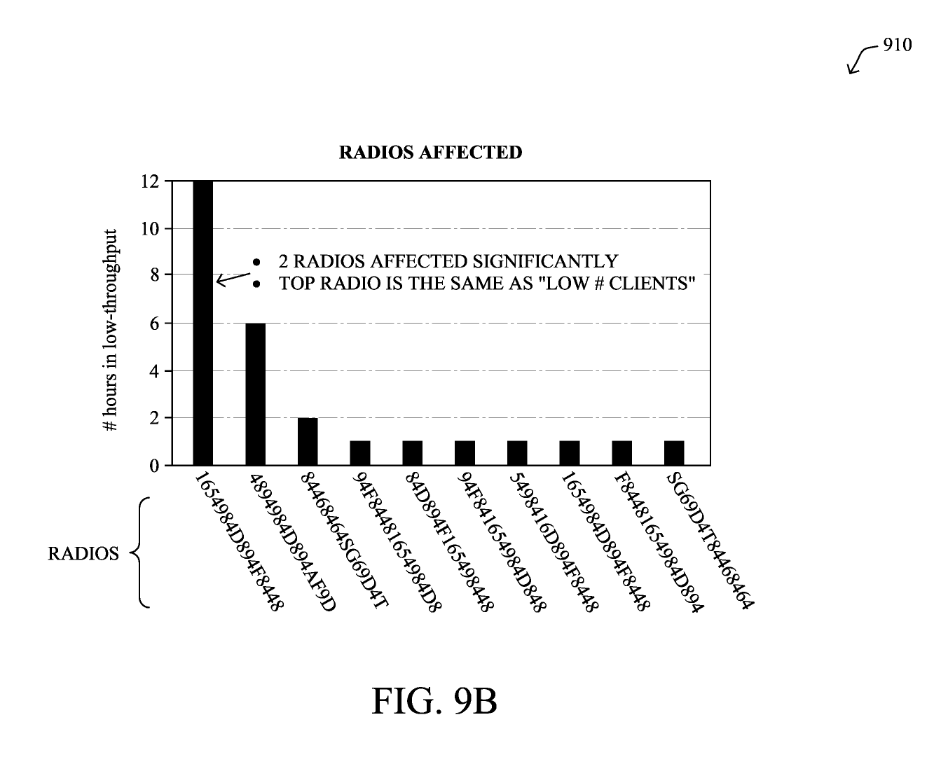

FIGS. 9A-9B illustrate examples of wireless features that affect throughput, according to various embodiments. As show in display 900 in FIG. 9A, assume that the user/administrator wishes to view more details about the traffic on channel 36, which was identified as one of the features present in a pattern associated with low throughput anomalies. In general, display 900 allows the user to assess further information, such as the number of radios affected, the number of clients, traffic, and low RSSI samples. The chart 910 in FIG. 9B can also be presented to the user, to help him or her further understand which of the radios are most associated with the low throughput anomalies. From this, the user can quickly determine that contention on channel 36 is causing the anomalies, due to a large number of clients being present on an already busy channel.

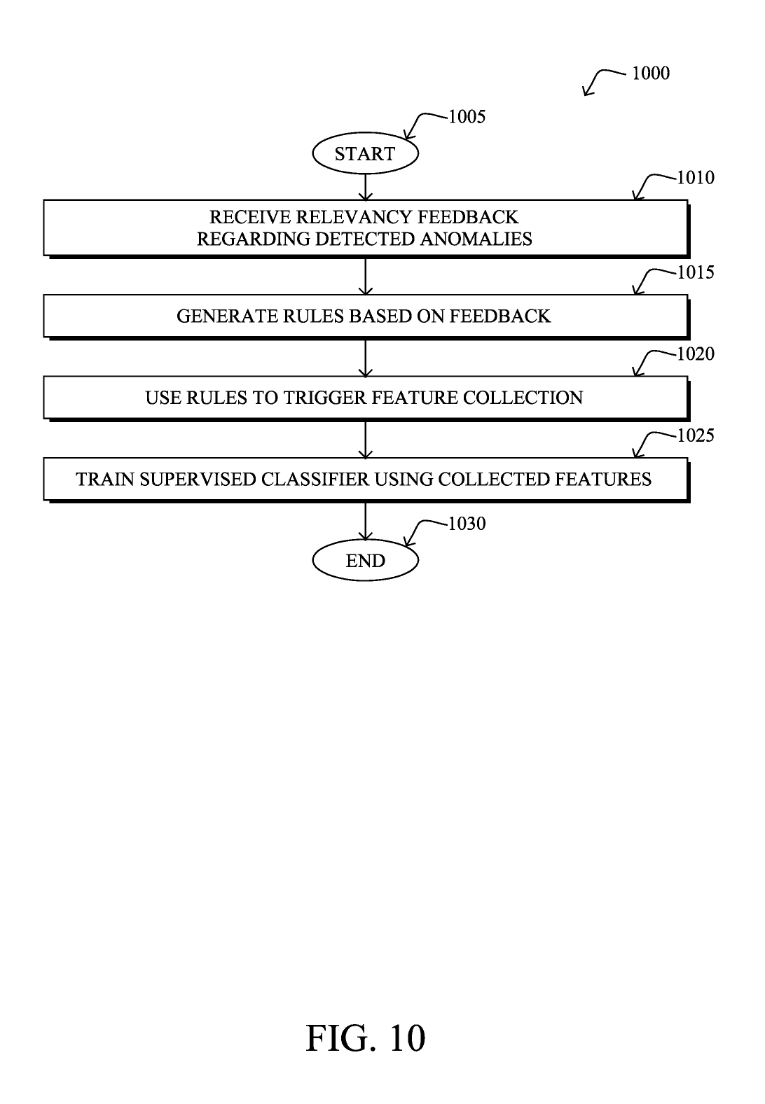

FIG. 10 illustrates an example simplified procedure for training a network classifier, in accordance with one or more embodiments described herein. For example, a non-generic, specifically configured device (e.g., device 200) may perform procedure 1000 by executing stored instructions (e.g., process 248), to provide a network assurance service. The procedure 1000 may start at step 1005, and continues to step 1010, where, as described in greater detail above, the service may receive relevancy feedback regarding detected anomalies in the network. In various embodiments, the anomalies may be detected by one or more unsupervised learning-based anomaly detectors. In turn, the system may provide information regarding the anomalies to a user interface, to obtain feedback regarding whether the user considers a given anomaly to be relevant/of importance.

At step 1010, as detailed above, the service may generate a set of rules based on the relevancy feedback. More specifically, the service may generate rules for those anomalies that the user deemed relevant. In general, the rules may define the features and values that are associated with the relevant anomalies. For example, the user may only be interested in anomalies whereby the roaming failure rate is greater than 90% or when the anomalies involve clients running a particular operating system.

At step 1015, the service may use the set of generated rules to trigger the collection of data features from the network, as described in greater detail above. Such rules may be configured to trigger the collection of data features from the network. For example, assume that the user indicates that anomalies that involve a particular operating system are of relevance. In such a case, the service can construct a rule to collect data features from anomalies involving clients that run the operating system.

At step 1020, as detailed above, the service may use the set of rules to trigger collection of data features from the network. In some cases, the service may deploy the rules to one or more network entities (e.g., routers, switches, WLCs, APs, etc.), that cause the entities to capture the data features when the rule is satisfied. For example, if the rule indicates that anomalies involving a certain operating system are of interest to the user (e.g., based on the relevancy feedback), the rule may trigger a network entity to perform packet capture and inspection, when anomalies are detected that involve clients running that operating system. In other cases, the rule can be implemented in the cloud, if the data features are already being reported.

At step 1025, the service may use the collected data features from the network to train a supervised learning-based classifier, as described in greater detail above. Notably, the service may use the collected feature data from the rules as training data, to train a supervised learning-based classifier. Notably, the captured data features may be labeled accordingly (e.g., “anomaly”) and used to train a classifier configured to detect anomalies, such as through analysis of traffic features in the network. In some embodiments, relevance feedback regarding the anomalies detected by the classifier can be used to further train or retrain the classifier, such as by exploring additional anomalous conditions. Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, leverage both unsupervised and supervised machine learning to dramatically increase the efficacy of anomaly detection in a monitored network, as well as providing only the most relevant anomalies for review by a user/administrator.

While there have been shown and described illustrative embodiments that provide for training a classifier, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a service, relevancy feedback regarding anomalies detected in a network by one or more unsupervised learning-based anomaly detectors;
generating, by the service, a set of rules based on those of the anomalies deemed relevant by the relevancy feedback;
using, by the service, the set of rules to trigger collection of data features from the network; and
training, by the service, a supervised learning-based classifier using the data features collected from the network.

2. The method as in claim 1, wherein the trained classifier is a decision tree classifier.

3. The method as in claim 1, wherein receiving the relevancy feedback regarding the detected anomalies comprises:
sending, by the service, data indicative of the anomalies to a user interface, wherein the data indicative of a particular one of the anomalies comprises measurements from the network associated with the particular anomaly; and
receiving, by the service, the relevancy feedback from the user interface.

4. The method as in claim 3, wherein the data indicative of the particular anomaly further comprises context data associated with the particular anomaly, and wherein the method further comprises:
retrieving, by the service, the context data associated with the particular anomaly from a network access control server or a Remote Authentication Dial-In User Service (RADIUS) server.

5. The method as in claim 1, wherein generating the set of rules based on those of the detected anomalies deemed relevant by the relevancy feedback comprises:
identifying, by the service, a pattern of data features across multiple ones of the detected anomalies; and
translating, by the service, the identified pattern of features into a particular one of the rules, wherein the particular rule comprises one or more thresholds for the data features in the pattern.

6. The method as in claim 1, wherein the data features collected from the network comprise at least one data features that was not used assessed by the one or more unsupervised learning-based anomaly detectors.

7. The method as in claim 1, wherein at least one of the detected anomalies comprises a wireless roaming failure anomaly or a low throughput anomaly.

8. The method as in claim 1, further comprising:
receiving, by the service, relevancy feedback regarding additional anomalies detected in the network by the one or more anomaly detectors; and
retraining, by the service, the supervised learning-based classifier based on the received relevancy feedback regarding the additional anomalies.

9. The method as in claim 1, wherein at least one of the data features comprises: an interference measurement, wireless channel information, or a wireless signal strength metric.

10. An apparatus comprising:
one or more network interfaces to communicate with a network;
a processor coupled to the network interfaces and configured to execute one or more processes; and
a memory configured to store a process executable by the processor, the process when executed configured to:
receive relevancy feedback regarding anomalies detected in a network by one or more unsupervised learning-based anomaly detectors;
generate a set of rules based on those of the anomalies deemed relevant by the relevancy feedback;
use the set of rules to trigger collection of data features from the network; and
train a supervised learning-based classifier using the data features collected from the network.

11. The apparatus as in claim 10, wherein the trained classifier is a decision tree classifier.

12. The apparatus as in claim 10, wherein the apparatus receives the relevancy feedback regarding the detected anomalies by:
sending data indicative of the anomalies to a user interface, wherein the data indicative of a particular one of the anomalies comprises measurements from the network associated with the particular anomaly; and
receiving the relevancy feedback from the user interface.

13. The apparatus as in claim 12, wherein the data indicative of the particular anomaly further comprises context data associated with the particular anomaly, and wherein the process when executed is further configured to:
retrieve the context data associated with the particular anomaly from a network access control server or a Remote Authentication Dial-In User Service (RADIUS) server.

14. The apparatus as in claim 10, wherein the apparatus generates the set of rules based on those of the detected anomalies deemed relevant by the relevancy feedback by:
identifying a pattern of data features across multiple ones of the detected anomalies; and
translating the identified pattern of features into a particular one of the rules, wherein the particular rule comprises one or more thresholds for the data features in the pattern.

15. The apparatus as in claim 10, wherein the data features collected from the network comprise at least one data features that was not used assessed by the one or more unsupervised learning-based anomaly detectors.

16. The apparatus as in claim 10, wherein at least one of the detected anomalies comprises a wireless roaming failure anomaly or a low throughput anomaly.

17. The apparatus as in claim 10, wherein the process when executed is further configured to:
receive relevancy feedback regarding additional anomalies detected in the network by the one or more anomaly detectors; and
retrain the supervised learning-based classifier based on the received relevancy feedback regarding the additional anomalies.

18. The apparatus as in claim 10, wherein at least one of the data features comprises: an interference measurement, wireless channel information, or a wireless signal strength metric.

19. A tangible, non-transitory, computer-readable medium storing program instructions that cause a device to execute a process comprising:
receiving, at the device, relevancy feedback regarding anomalies detected in a network by one or more unsupervised learning-based anomaly detectors;
generating, by the device, a set of rules based on those of the anomalies deemed relevant by the relevancy feedback;
using, by the device, the set of rules to trigger collection of data features from the network; and
training, by the device, a supervised learning-based classifier using the data features collected from the network.

20. The computer-readable medium as in claim 19, wherein generating the set of rules based on those of the detected anomalies deemed relevant by the relevancy feedback comprises:
identifying, by the device, a pattern of data features across multiple ones of the detected anomalies; and
translating, by the device, the identified pattern of features into a particular one of the rules, wherein the particular rule comprises one or more thresholds for the data features in the pattern.
